(19) United States
(12) Patent Application Publication
(10) Pub. No.: US 2009/0016608 A1
(43) Pub. Date: Jan. 15, 2009

(54) CHARACTER RECOGNITION METHOD

(75) Inventors: Katsuhito Fujimoto, Kawasaki (JP); Misako Suwa, Kawasaki (JP); Satoshi Naoi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/168,370

(22) Filed: Jul. 7, 2008

(30) Foreign Application Priority Data
Jul. 10, 2007 (JP) 2007-181393

(51) Int. Cl. G06K 9/00

(52) U.S. Cl. 382/189

(57) ABSTRACT

According to an aspect of an embodiment, a method of character recognition out of an image having a frame and a plurality of characters in an area, comprises the steps of: dividing the area into a plurality of partial areas having a plurality of partial images, respectively; providing a template image having a reference frame image; calculating differences between the partial images and the reference frame image of the template image, respectively; calculating misalignment of the image from the template image based on the average of the differences of the partial images and the reference frame image; and recognizing the characters out of the image upon correction of the misalignment.

### BACKGROUND OF THE INVENTION

1. Field of the Invention

The invention relates to a method for reading image information.

2. Description of the Related Art

The optical Character Recognition (which will be called OCR hereinafter) technology is available as processing of reading image information to a computer. The OCR technology is a technology that detects a characteristic from a form rendered on an image and outputs text code information, which can be handled by a computer. For example, the OCR technology may be used for reading reports. A report has a predefined area thereon on which a characteristic is to be written. The area is defined by a frame line drawn on a report. The OCR technology must accurately detect the area on which a characteristic is to be written. For accurate detection of the area on which a characteristic is to be written, it is effective to identify the position, angle, size and so on of the frame line. The position of the frame line, for example, may be identified precisely based on the amount of displacement between the frame line information of report image data, which is a template held in advance, and the frame line information obtained from image data of an input report.

The frame line information, for example, of a report may include multiple color information pieces or include multiple density levels (which will be called color report). In a case where the OCR technology is applied to a color report, a predetermined color information piece of read color report image information is deleted. Text information is detected from the report image data after the color information piece is deleted therefrom. When a color information piece is deleted from a color report, partial frame line information of the report image information may also be deleted or partial unnecessary noise information of the report image information may remain.

A Generalized Hough Transform is available as a method for calculating an amount of displacement between template image information and input image information. The Generalized Hough Transform holds report templates having complex and various structures as reference images. The Generalized Hough Transform defines a voting space for each deformation parameter such as PARALLEL, ROTATE and EXTEND/CONTRACT and estimates the amount of displacement of an input image by voting to a voting space for each parameter. The Generalized Hough Transform can estimate the amount of displacement between an input report image and a report image of a template in a case where the input report image is a report image having a complex structure and noise and/or a break in the frame line. A technique related to the above techniques is disclosed in Japanese Laid-open Patent Publication No. 10-27208 and Japanese Patent No. 3756309.

However, the Generalized Hough Transform requires a huge memory space for implementation of a voting space and a huge processing time for voting.

### SUMMARY

According to an aspect of an embodiment, a method of character recognition out of an image having a frame and a plurality of characters in an area, comprises the steps of: dividing the area into a plurality of partial areas having a plurality of partial images, respectively; providing a template image having a reference frame image; calculating differences between the partial images and the reference frame image of the template image, respectively; calculating misalignment of the image from the template image based on the average of the differences of the partial images and the reference frame image; and recognizing the characters out of the image upon correction of the misalignment.

### BRIEF DESCRIPTION OF THE DRAWINGS

FIG. 1 is a hardware configuration diagram of an image processing apparatus 1;

FIG. 2 is a flowchart of processing from the receipt of input image information 17 to output of a corrected image;

FIG. 3 is an example of the input image information 17;

FIG. 4 is an image of the binarization of template image information 18;

FIG. 5 is a set value 21-1 of a horizontal edge filter of Sobel;

FIG. 6 is a set value 21-2 of a vertical edge filter of Sobel;

FIG. 7 is a diagram resulting from the division of the input image information 17 into multiple partial image areas;

FIG. 8 is an explanatory diagram for application of Bucket method;

FIG. 9 is a partial image area of the template image information 18;

FIG. 10 is an example of a comparison vector 190;

FIG. 11 is a flowchart of voting processing;

FIG. 12 is a configuration example of the voting space;

FIG. 13 is a conceptual diagram of the voting processing;

FIG. 14 is an explanatory diagram for calculation of a displacement parameter corresponding to each pixel;

FIG. 15 is a diagram showing a partial area 55 of the input image information 17.

### DESCRIPTION OF THE PREFERRED EMBODIMENTS

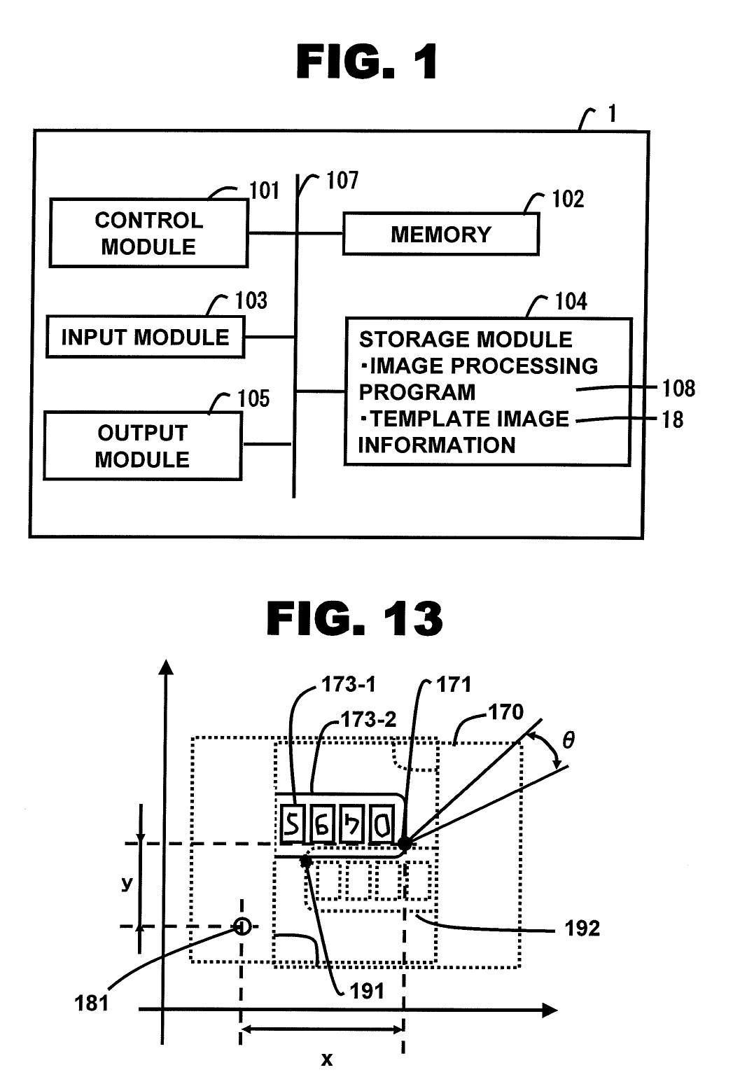

FIG. 1 is a hardware configuration diagram of an image processing apparatus 1. The image processing apparatus 1 includes a control module 101, a memory 102, an input module 103, a storage module 104 and an output module 105, which connect to a bus 107.

The control module 101 controls the entire image processing apparatus 1. For example, the control module 101 may be a central processing unit (CPU). The control module 101 executes an image processing program 108, which is expanded in the memory 102. The image processing program 108 causes the control module 101 to function as a contour point set creating module, a partial image voting module, a parameter narrowing module, a partial image pasting module and so on. The control module 101 has a function of converting a string image rendered on a report to text code information, which can be handled by a computer, in a case where the input image information 17 is of a report.

The memory 102 is a storage area in which the image processing program 108 stored in the storage module 104 is to be expanded. The memory 102 is a storage area that stores various operational results, which are created when the control module 101 executes the image processing program 108. The memory 102 may be a random access memory (RAM).

The input module 103 receives information on various commands or images to be given from a user to the control module 101. The input module 103 may be a keyboard, a mouse or a touch panel. The input module 103 may be an image scanner, for example. The storage module 104 may be a hard disk drive, for example. The storage module 104 may store the image processing program 108, reference image information (which will be called template image information hereinafter) 18, which is a reference report image, input image information 17 and so on. The output module 105 outputs result information from image processing. The output module 105 may be a display (display apparatus), for example.

The contour point set creating module extracts the contour of a form rendered within an image from the input image information 17. The contour point set creating module creates a point set (input image contour point set) constructing the contour of frame line information (stroke) contained in the input image information 17. The frame line is rendered in order to define an input area for text within a report or to show a characteristic of a report more clearly. The contour point set creating module can identify in advance the point set (template contour point set) of the contour contained in the template image information 18. For example, the contour point set creating module defines the template contour point set when the template image information 18 is registered. The contour point set creating module stores the defined template contour point set to the storage module 104. The contour point set creating module obtains the input image contour point set and the template contour point set corresponding to each partial image area resulting from the division of the input image information 17 into a grid pattern.

The partial image voting module uses the template contour point set and input image contour point set corresponding to each partial image area resulting from the division of the input image information 17 into a grip pattern to vote onto a voting space illustrating a displacement parameter based on the principle of a Generalized Hough Transform. As a result of the voting by the partial image voting module, the area with a higher voting frequency within the voting space can be the estimated value of the displacement parameter.

The parameter narrowing module switches the operation parameter (resolution) of the Generalized Hough Transform from a low resolution to a higher resolution in a stepwise manner. The operation parameter is a value of the first digit if the target precision is the second decimal place. After the candidate for the first digit is obtained, the operation parameter is assumed as the value of the first decimal place. By repeating this processing, the displacement parameter is calculated with a target precision. The parameter narrowing module allows gradual narrowing of candidates of the displacement parameter while suppressing enormous increases in the number of contour points and/or the size of the voting space representing the displacement parameter.

The partial image pasting module extracts displacement parameters with a higher reliability among the displacement parameters calculated from the areas resulting from the division of an image into a grid pattern. The partial image pasting module calculates the displacement parameter for each pixel within the input image information 17 by interpolating the displacement parameters of the partial image areas. As a result, the partial image pasting module can smoothly paste the partial image areas even in a case where the displacement parameters differ among the partial image areas. The partial image pasting module outputs a corrected image resulting from the positional correction with the displacement parameters corresponding to the pixels within the input image information 17.

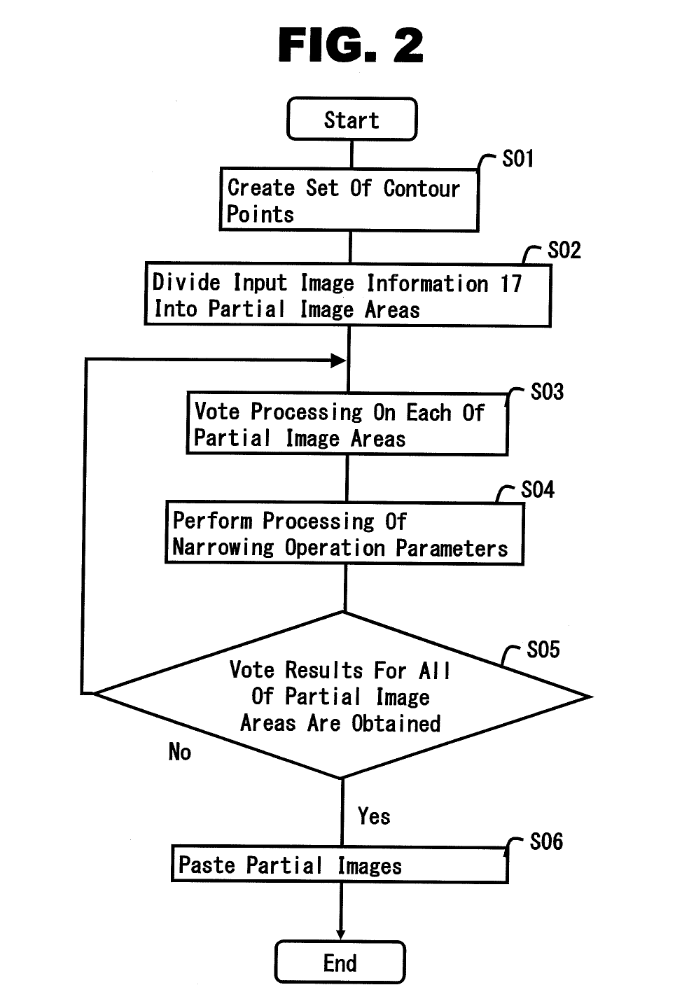

Next, the processing from the receipt of the input image information 17 to the output of the corrected image according to this embodiment will be described. FIG. 2 is a flowchart of the processing from the receipt of the input image information 17 to the output of a corrected image. The control module 101 creates a set of contour points from the input image information 17 (S01). The control module 101 divides the input image information 17 into partial image areas (S02). The control module 101 divides the input image information 17 into a grid pattern by rectangles in a predetermined size. The dividing rectangles are called partial image areas. The control module 101 performs voting processing by Generalized Hough Transform on each of the partial image areas (S03). The control module 101 performs the processing of narrowing the operation parameters for the voting processing (S04) when the Generalized Hough Transform is performed in S03. The control module 101 performs the voting processing on the partial images in S03 until the voting results for all of the partial image areas are obtained (S05: NO). If the voting results for all of the partial image areas are obtained (S05: Yes), the control module 101 performs the processing of pasting the partial images (S06). The steps will be described in detail below.

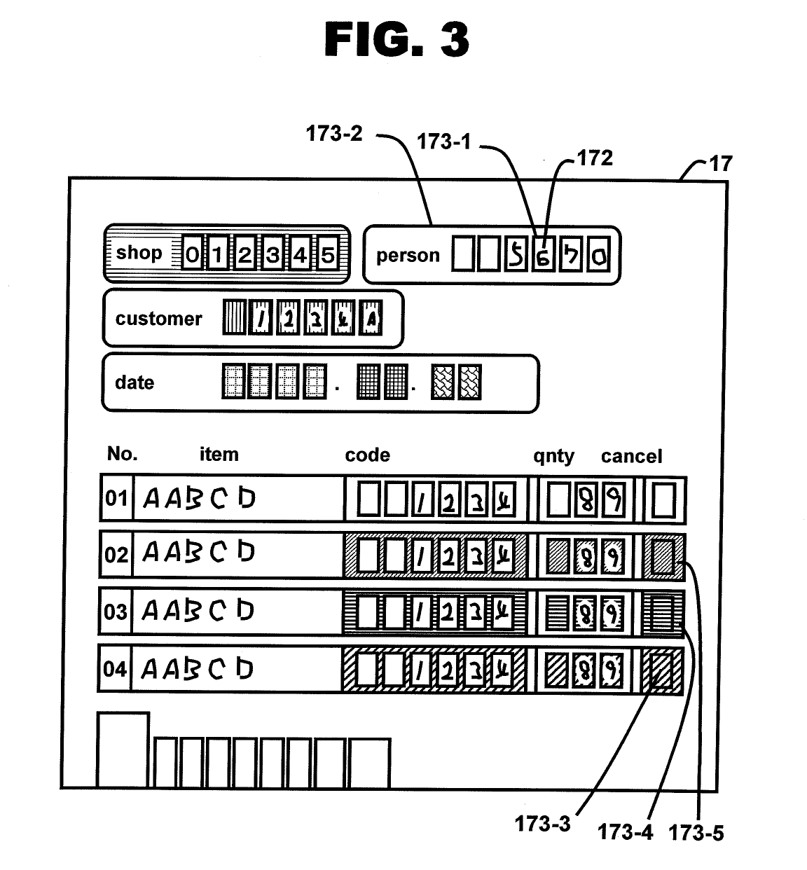

The input image information 17 of this embodiment may be a black-and-white binary report, a color report or a gray-scale report. FIG. 3 is an example of the input image information 17. The input image information 17 has frame line information 173-1, frame line information 173-2 and text information 172. The frame line information 173-1 is a frame to which a characteristic is to be input. The frame line information 173-2 is a frame clarifying a characteristic of a report while it is not an area to which a characteristic is directly written. The image processing apparatus 1 obtains a corrected image, which accurately locates the frame line information 173-1 in order to detect text information 172 with high precision. In order to obtain the corrected image, the image processing apparatus 1 aligns the frame line information 173-1 and frame line information 173-2 with the template image information. The frame line information 173-1, 173-4 and 173-5 are of the colored frames among the frames of the input image information 17.

The control module 101 performs dropout processing on the input image information 17. The dropout processing is processing of defining not to handle, as image information in the subsequent image processing, a part in a specific color (dropout color) among colors of lines and/or text printed on a report in advance.

Next, the contour point set creating processing in S01 will be described. According to this embodiment, the contour point set creating module performs processing of binarizing an input image by a Niblack method for a report in color and a gray scale. The Niblack method is a local binarization processing method. The Niblack method is a binarization method that defines surrounding information on a subject pixel (such as a rectangle with each side having a length equal to five pixels and a rectangle with each side having seven pixels) and obtains a threshold value for each pixel. First of all, a rectangle filter is defined as background separating processing. Either background part or information part is determined from the density scattered value within the rectangle filter. Then, the threshold value (σmin) for separating from the background is defined, and it is determined that there is information if the calculation result within the filter is equal to or higher than σmin. If the density scattered value is equal to or higher than the threshold value (σmin), the threshold value of the density of a focused pixel k is obtained, and either white pixel or black pixel is determined. The black pixel in the subsequent processing is a pixel subject to the operation. The black pixels may be included in an edge line of a frame line or text information. The contour point set creating module creates a contour point set of a stroke within the converted binary image information.

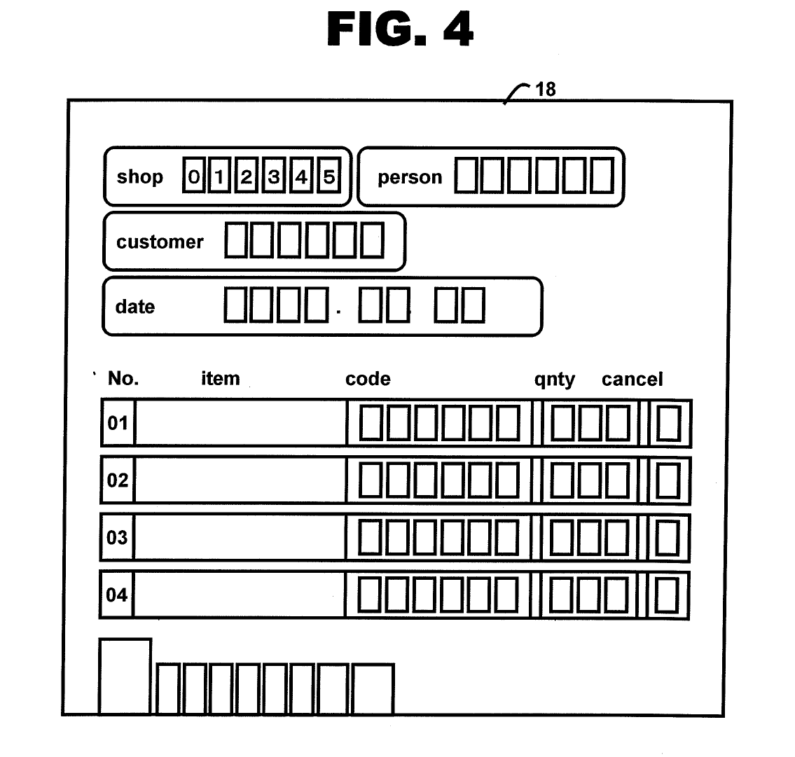

FIG. 4 shows the template image information 18. The template image information 18 is an image resulting from the binarization of a report. The template image information 18 is a reference on which the form of the frame line of a report is based. The form of the frame line is identified by the distance from a reference point, the angle, the size of the extension/contract of the frame line and/or the direction of the extension/contract of the frame line, for example. In the report case, the position where a characteristic is input can be identified. In a case where coordinates information of an area where text of the template image information 18 is to be input is known, it is easy to detect text form information when the apparatus performs processing of reading text data. Therefore, a string within a frame line of the input image information 17 can be read out with high precision by matching the form resulting from the positional rotation angle, extension/contract or the like of the frame line to the form of the frame line of the template image information 18.

Examples of the set value used to apply the Niblack are as follows. the length of one side of the window subject to the local Niblack is “5”. The set value of Niblack is “−0.1” here. The set value is calculated by adding the average density difference threshold value to the value resulting from the multiplication of the density of a focused pixel k by a standard deviation. The average density difference threshold value is “8.0” here. The average edge strength threshold value is “8.0” here. The number-of-edges threshold value is “6”.

Here, another method for the contour point set creating processing in S02 will be described. The contour point set creating module extracts a set of contour points from the input image information 17 having color/shades pixel values through a Sobel edge filter. The contour point set creating module creates a set of pixels constructing a frame line of the extracted input image information 17.

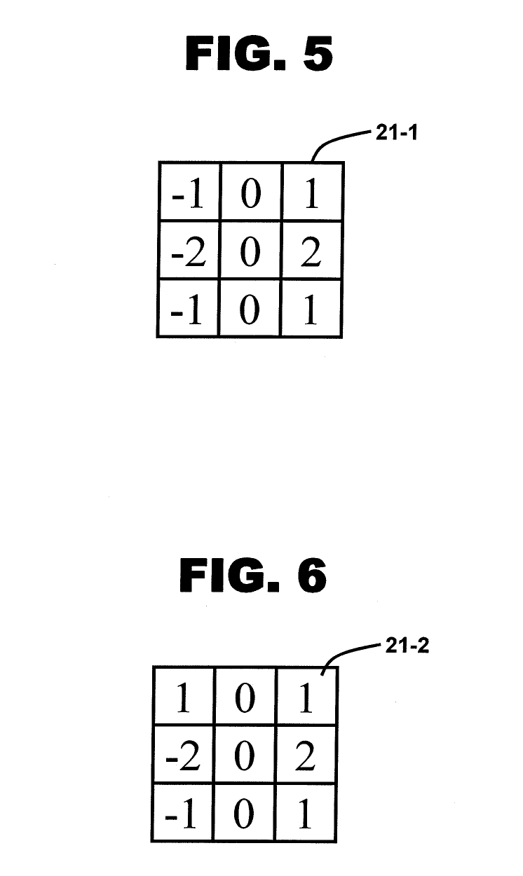

The contour point set creating module performs area division on the image by using a Sobel edge filter. The area division is processing of obtaining pixels of a stroke, which is not the background within the input image information 17. The contour point set creating module determines whether the focused pixel is a pixel of the background or not by comparing the value of the edge detected for the pixel and a predetermined threshold value. FIG. 5 is a set value 21-1 of a Sobel horizontal edge filter. FIG. 6 is a set value 21-2 for a Sobel vertical edge filter. The contour point set creating module calculates the edge value of each pixel of the input image information 17. For example, the contour point set creating module may define the edge value so as to be the value integrated to 255 or below. For example, in a case where the density threshold value is set to 25 in advance, the contour point set creating module determines that the focused pixel is a black pixel if the edge value is lower than 25.

The edge value may be set according to the report. For example, in a case where there is a small difference in color between the background color and extracted text color in a color report, the edge value must be set lower. On the other hand, if there is a large difference in color between the background color and the text color to be extracted, the extraction is possible even by setting the edge value higher. Here, the horizontal component value is H, and the vertical component value is V. The contour point set creating module calculates the edge value by following equation (EQ1).

Edge=0.16·\sqrt{(H²+V²)} (EQ1)

In a case where a subject of the image processing is a report image, the edge component of the horizontal component and the edge component of the vertical component may be the subjects of the processing of Generalized Hough Transform. This is because the form of the frame or text of a report image has more longitudinal (vertical) line segments or lateral (horizontal) line segments than those on a general report. The Generalized Hough Transform also considers the direction component of a black pixel. Therefore, in a case of a report image, the contour point set creating module extracts the edge component of the horizontal component and the edge component of the vertical component from the direction components of obtained various edge components. Alternatively, the contour point set creating module is configurable to sort the direction components of obtained various edge components into the edge component of the horizontal component and the edge component of the vertical component. This configuration can reduce the time required for calculating a displacement parameter by the partial image voting module since the number of elements to be compared is reduced in the Generalized Hough Transform.

In a case where a report image is a subject, the edge component of the horizontal component only may be the subject of the Generalized Hough Transform, or the edge component of the vertical component only may be the subject of the Generalized Hough Transform. In this case, the contour point set creating module applies the processing of calculating a displacement parameter by the Generalized Hough Transform to any one of the horizontal component and vertical component. This configuration can reduce the time required for calculating a displacement parameter in the partial image voting module since the number of elements to be compared in the Generalized Hough Transform can be more reduced. The contour point set creating module may handle the direction component having more pixels as the subject of the processing of calculating a displacement parameter by the Generalized Hough Transform.

Next, the processing of dividing the input image information 17 into partial image areas will be described.

The partial image voting module divides the input image information 17 in a grid pattern. The range of the division in a grid pattern is defined in advance. The range to be divided depends on the form of a report. The range is divided so as to include a unit of unique element within an image of a report. Since dividing a report finely can reduce the number of times of voting processing on one range, the amount of calculation by the partial image voting module can be advantageously reduced. On the other hand, the range resulting from the fine division of a report does not have any feature of a figure, which disadvantageously reduces the reliability of the processing result by the partial image voting module. Accordingly, the area covering a feature part within a report is defined as the range.

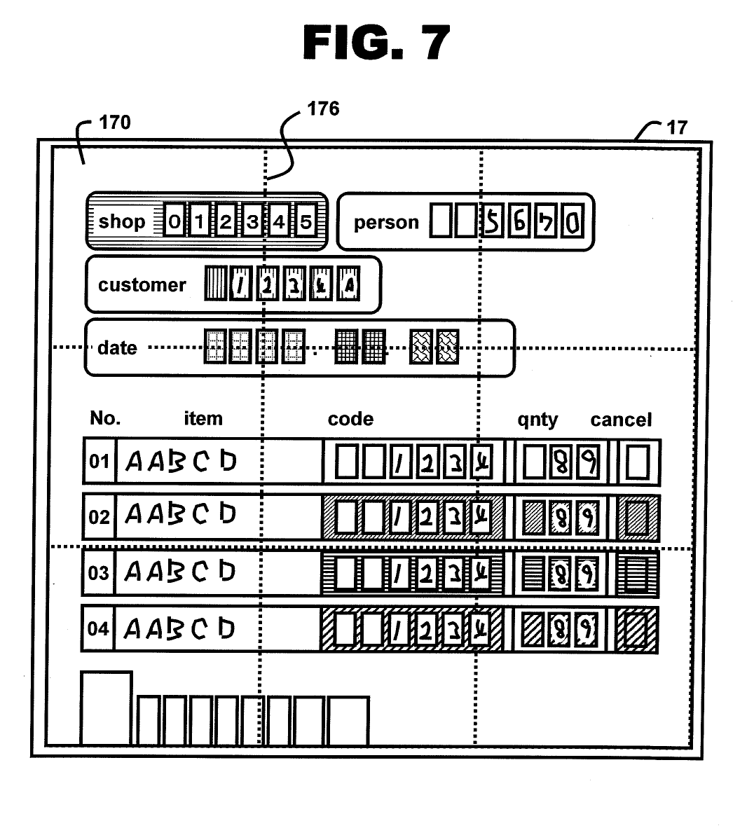

FIG. 7 is a diagram in which the input image information 17 is divided into multiple partial image areas. The reference numeral 176 refers to a line dividing the input image information 17. According to this embodiment, the lines 176 divide the input image information 17 into a grid pattern. For example, when a table having continuous grid shapes is divided into multiple ranges, the peak value of a displacement parameter occurs at each intersection of the grids. The occurrence of a false peak in the Generalized Hough Transform can be prevented by defining the entire table as the range. In FIG. 7, the partial image voting module divides the input image information 17 into nine partial image areas 170 of horizontal three by vertical three.

Next, the processing of voting a partial image in S03 will be described. The partial image voting module calculates a displacement parameter from the template contour point set corresponding to each partial image area and an input image contour point set. The partial image voting module calculates the displacement parameter by the principle of the Generalized Hough Transform. The Generalized Hough Transform votes onto a voting space representing displacement parameters. The Generalized Hough Transform outputs an estimated value for the parameter from the parameter partial image area with a high voting frequency in a voting space.

The voting space is defined by the partial image voting module by a Bucket method. The Bucket method is one method of Computer Science. The Bucket method divides a subject having a spatial extent into small areas. The application of the Bucket method can increase the speed of processing since the Generalized Hough Transform can be applied to each partial image area.

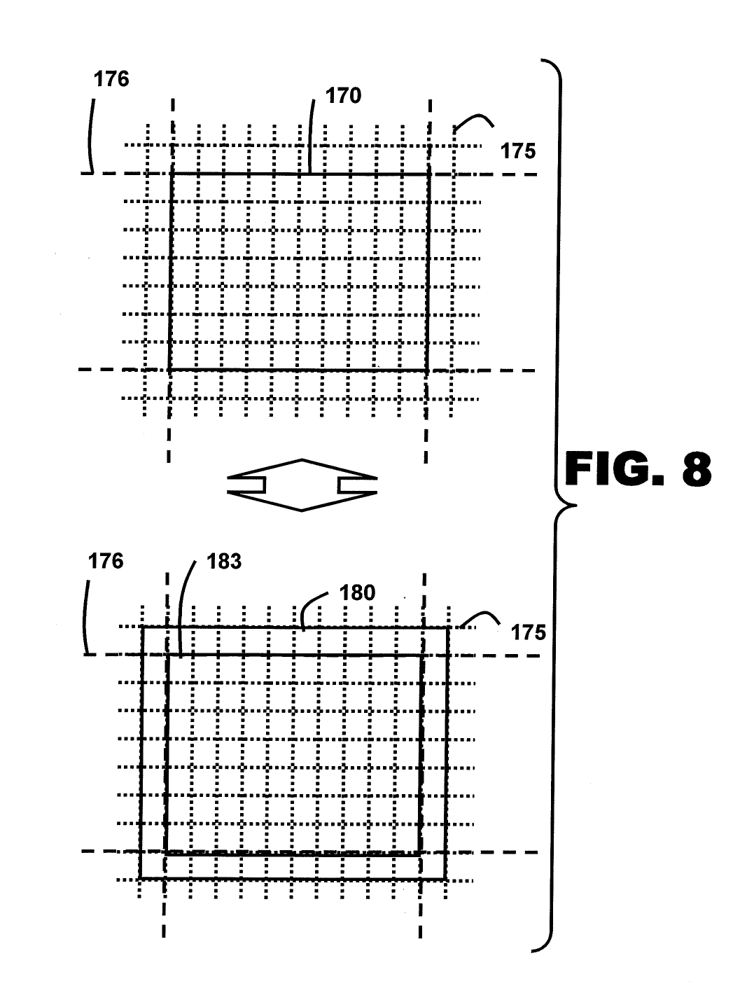

FIG. 8 shows an explanatory diagram for the application of the Bucket method. The partial image voting module further divides the partial image area 170 of the input image information 17 resulting from the division in a grid pattern in S02. The reference numeral 175 refers to a grid line dividing the partial image area 170. The distance between the dividing grid lines is defined in advance. For example, a maximum amount of displacement, which is expected as occurring in an image scanner apparatus, for example, is defined. In a case where the amount of displacement occurring in the image scanner is 1 cm, the partial image voting module creates grid lines at intervals each of which is equivalent to 1 cm of a paper report. The reference numeral 183 refers to the area of the template image information 18 corresponding to the partial image area 170 of the input image information 17. The partial image voting module handles the area surrounded by the grid lines 175 in the area 183 as the partial image area 180 of the template image information 18.

The partial image voting module calculates a displacement parameter by applying the principle of the Generalized Hough Transform to each partial image area. The partial image voting module uses a template contour point set and an input image contour point set to estimate the parameter that allows a maximum number of votes in a voting space as the displacement parameter. The Generalized Hough Transform is an application of a Hough Transform. The Hough Transform is a method that transforms from the original (x,y) coordinate system to a (r,θ) polar coordinate system and detects a form of a straight line based on the polar coordinate system. The Generalized Hough Transform can extract a parameter for parallel movement/rotation/extension or contract or the like for not only a straight line but also a figure in an arbitrary form. According to this embodiment, the parameter calculated by the Generalized Hough Transform is the displacement parameter for a report. The Generalized Hough Transform votes a difference in coordinates between a template contour point set and an input image contour point set and handles the most voted parameter as the parameter to be obtained. Since the Generalized Hough Transform polls a parameter with a maximum number of votes, the detection with high precision is allowed even when a subject image has noise or a break.

The processing of the Generalized Hough Transform according to this embodiment will be described. The partial image voting module votes onto a voting space representing displacement parameters by following processing.

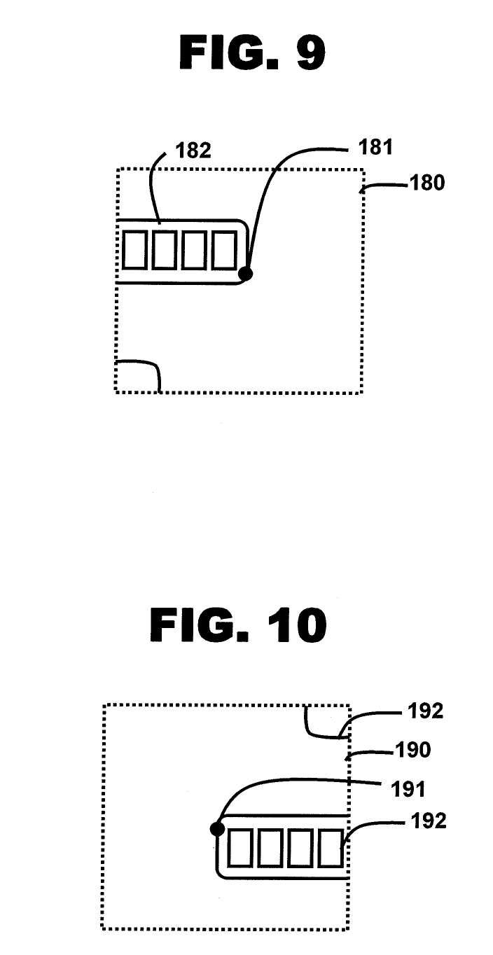

The partial image voting module defines vectors from a reference point within a partial image area of the template image information 18 and a reference point in the template image information 18 to each black pixel on the part image area 180. FIG. 9 shows a partial image area of the template image information 18. The reference numeral 180 refers to a partial image area of the template image information 18. The reference numeral 181 refers to a reference point within the partial image area 180. The reference point 181 is defined in advance. The reference numeral 182 refers to a template contour point set within the partial image area 180.

The partial image voting module defines a comparison vector, which is a vector symmetric with respect to the reference point 181. FIG. 10 is an example of the comparison vector. The reference numeral 191 is the center of the symmetry between the comparison vector 190 and the partial image area 180. The center 191 corresponds to the reference point 181. The reference numeral 192 refers to a template contour point set for the comparison vector 190. The comparison vector 190 and the template contour point set 182 are symmetric with respect to a point. Therefore, in a case where the center 191, which is the subject of the comparison vector, is above the template contour point set 182, the template contour point set 192 always passes through the reference point 181. Notably, the Generalized Hough Transform may consider not only the overlaps of pixels but also the overlaps of direction vectors of pixels. Increasing the number of parameters for the Generalized Hough Transform can increase the precision of calculation of an amount of displacement, which however results in an enormous amount of calculation. Accordingly, the dimension of a parameter is defined according to the processing ability of the hardware of the image processing apparatus 1.

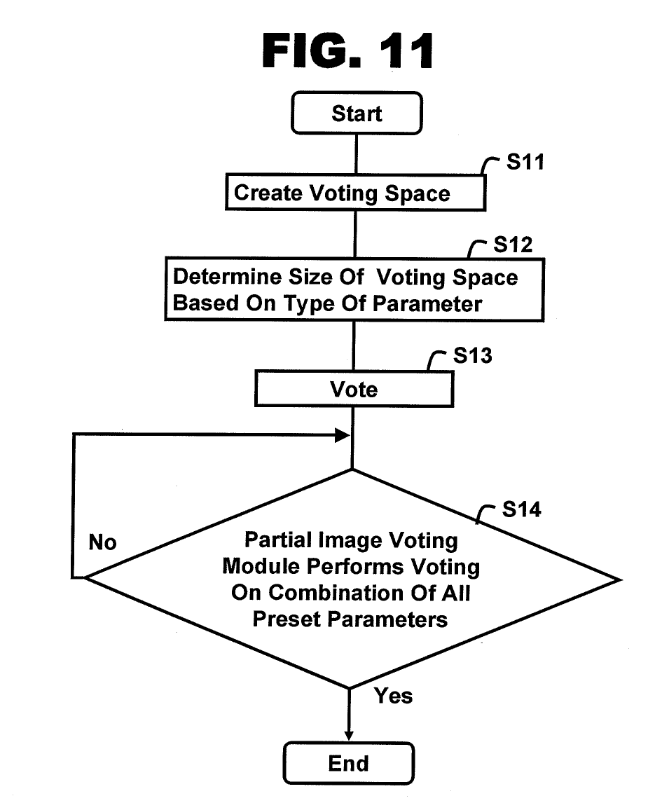

The partial image voting module performs the voting processing by following processing. FIG. 11 is a flowchart of the voting processing. The partial image voting module creates a voting space (S11). The voting space is a multi-dimensional space.

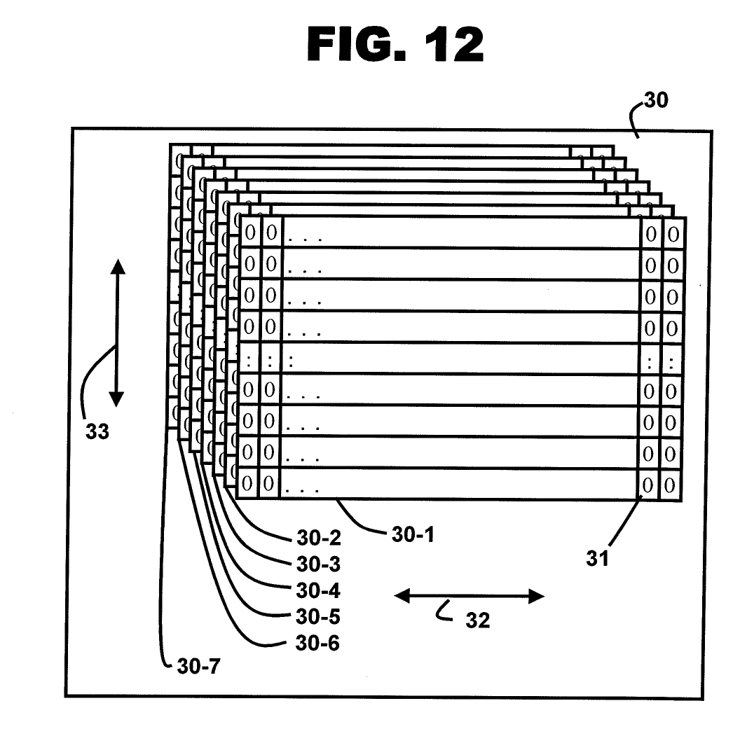

FIG. 12 is a configuration example of the voting space. The reference numeral 30 refers to a data configuration diagram of the voting space. The reference numerals 30-1 to 30-7 are areas storing the numbers of votes for a horizontal axis direction position 32 and a vertical axis direction position 33. The areas 30-1 to 30-7 are areas in a case where the angle of the comparison vector 190 is rotated by one degree. In addition, the space is increased based on the scaling of linear extension/contract and/or the direction of linear extension/contract. The reference numeral 31 refers to an area for storing the number of votes created for each parameter.

The partial image voting module determines the size of the voting space based on the type of parameter such as the horizontal axis direction position, the vertical axis direction position, the rotational angle, the scaling of linear extension/contract and the direction of linear expansion/contract and the precision of the parameter (S12).

Next, the partial image voting module determines the subject to be voted by following steps and votes it onto the voting space (S13). Notably, the Generalized Hough Transform can consider the direction vector of a contour line. For simple description, the description on the direction vector of a contour line will be omitted in this description of this embodiment.

FIG. 13 is a conceptual diagram of the voting processing. The reference numeral 170 refers to a partial image area of the input image information 17. The reference numeral 171 refers to a reference point of the partial image area 170. It is assumed here that the reference point 171 is displaced by x laterally, y longitudinally and a rotational angle θ with respect to the reference point 181 in the partial image area 180 of the template image information 18.

The partial image voting module identifies the rotational direction of the comparison vector 190 based on the parameter of the current rotational angle. The partial image voting module places the center, which is the subject of the rotated comparison vector 190, over the position of the partial image area 170 of the input image information 17, the horizontal axis direction and vertical axis direction of which are identified based on the parameters. The partial image voting module votes to the horizontal axis direction position and the vertical axis direction position of the input image contour point sets 173-1 and 173-2 within the partial image area 170 where the comparison vector 190 overlaps with the template contour point set 192. In a case where the parameter values of x horizontally, y vertically and rotational angle θ indicate an amount of displacement and the subject center 191 is placed over the input image contour point set 173-1 and 173-2, the template contour point set 192 always passes through the reference point 171. The partial image voting module can obtain the reference point, which can be a maximum value with a specific parameter.

The partial image voting module performs the voting processing on all pixels within the partial image area 170. The partial image voting module can also define the subject center 191 of the comparison vector 190 only on a black pixel of the partial image area 170. By performing the voting processing only on a black pixel of the partial image area 170, the amount of operation required for voting can be advantageously reduced more than that of the voting processing on all pixels of the partial image area 170.

In a case where the subject for which a displacement parameter is to be calculated is a report, the values (x, y) of parallel movement and value (θ) of the rotational angle between the input image information 17 and the template image information 18 are within a limited range. Therefore, the Generalized Hough Transform according to this embodiment votes by using a pair of the values (x, y) for each value θ of the limited rotational angle, and a combination of the value θ of the rotational angle, which has been voted most, and the values (x, y) of a parallel movement is obtained as a result of the calculation of the displacement parameter.

The partial image voting module repeats the processing in S12 and S13 until the voting processing is performed on the combination of all preset parameters (S14: No). After the partial image voting module performs the voting processing on the combination of all preset parameters (S14: Yes), the partial image voting module detects the maximum parameter from the obtained distribution diagram of the voting space. The maximum parameter is estimated as an Affine transformation matrix between the partial image area 180 of the template image information 18 and the partial image area of the input image information 17. The Affine transformation matrix can be the displacement parameter.

The input image information 17 used in this embodiment is equivalent to the result of Affine transformation on the template image information 18 with the displacement parameter. The Affine transformation is linear transformation such as parallel movement and rotation. Therefore, a corrected image resulting from the correction of a displacement can be created by performing the inverse transformation on the input image information 17 with the displacement parameter.

The partial image voting module obtains horizontal axis travel Tx, a vertical axis travel Ty and a rotational angle θ as the displacement parameters. The partial image voting module obtains parameters of the scaling of linear extension/contract and the direction of linear extension/contract when the voting processing is performed on the scaling of linear extension/contract and the direction of linear extension/contract. The displacement parameters are Affine transformation matrixes, and input image information and a template report image have a relationship of linear mapping. The transformation equation is present by a following equation (EQ2).

$$\begin{matrix}{x}^{′} = ( x \cdot cos θ ) - ( y \cdot sin θ ) + Tx \\ {y}^{′} = ( x \cdot sin θ ) - ( y \cdot cos θ ) + Ty\end{matrix} ) \qquad ( EQ 2 )$$

The values (x,y) in EQ2 are coordinates before the transformation. According to this embodiment, they are coordinates of a pixel of the template image information 18. The values (x′,y′) are coordinates after the transformation. According to this embodiment, they are coordinates of a pixel in the input image information 17. The symbols Tx, Ty and θ are Affine transformation matrixes.

The equation (EQ3) for obtaining corrected image information from the input image information 17 by (EQ2).

$$\begin{matrix}{x}^{′} = ( {y}^{″} - Ty ) \cdot sin θ + ( {x}^{″} - Tx ) \cdot cos θ \\ {y}^{′} = ( {y}^{″} - Ty ) \cdot cos θ - ( {x}^{″} - Tx ) \cdot sin θ\end{matrix} ) \qquad ( EQ 3 )$$

The values (x″,y″) of (EQ3) are coordinates of a pixel of a corrected image.

Next, the parameter narrowing processing in S04 will be described. In order to reduce the amount of calculation required for image processing, this embodiment performs multi-level processing with multiresolution. The displacement parameters of image information to be obtained by the Generalized Hough Transform according to this embodiment are parameters of displacements by horizontal and vertical parallel movement, a displacement by rotational movement and parameters of the direction of linear extension/contract, the scaling of linear extension/contract and so on. The Generalized Hough Transform requires a memory area storing a voting result for each parameter with a target precision. The size of the voting space increases by the order of multipliers the number of which is equal to the number of types of parameters. Therefore, performing an operation for obtaining three-dimensional parameters with a target precision from the beginning results in an enormous amount of processing time required for image processing and an enormous amount of memory space for storing the three-dimensional parameters.

Accordingly, the parameter narrowing module performs multilevel processing of first obtaining rough estimated values for a displacement parameter and precisely obtaining the parameter around the rough estimated values. The parameter narrowing module changes the result of a partial image area from a rough one to a fine one. As a result of the change of the resolution in multilevel, the enormous size of the voting space representing the number of contour points and/or displacement parameters can be prevented, and the candidates for an optimum parameter can be narrowed gradually. As a result, the amount of calculation in the voting processing to be performed by the parameter narrowing module can be reduced, and a displacement parameter can be calculated without any decrease in precision. For example, the amount of change (number of steps) of a subject of the Generalized Hough Transform, which is defined for obtaining the estimated value, may be defined such that the result can fit within a memory area within the image processing apparatus 1 and can use the entire memory area.

For example, the parameter narrowing module may define the increment of the parameter for a voting space by the following method. The parameter narrowing module calculates a memory area, which is available to each parameter, from the range that the parameter can have and the size of the memory area. In cases of parallel movement (horizontally and vertically) and rotational angles, the memory areas are three-dimensional, and the parameter narrowing module divides the memory areas into three. Next, the parameter narrowing module obtains an optimum increment of each parameter from the range that the parameter can take, each amount of memory storing the parameter and the amount of memory allocated to the subject parameter.

An example in which an angle parameter is calculated will be described below. In a case where the partial image voting module requires a processing time α (ms) for one vote and where the number of evaluation angles is β, the processing time required until the Affine transformation matrix is obtained is αβ (ms). Accordingly, the parameter narrowing module with multiresolution narrows the β evaluation angles in steps.

In the voting processing in the first step, the parameter narrowing module divides the evaluation angle into n ranges and uses the center angle of each of the ranges to obtain the angle to be voted most. The voting processing in the first step is processing for the purpose of narrowing the angle ranges. Since the precision of voting positions is not required, the parameter narrowing module reduces the number of black pixels subject to the voting processing by using images having less black pixel information resulting from the reduction of the input image information 17 and can further reduce the processing time.

In order to relieve the situation that an unintentional angle is accidentally voted most, the angle to be selected as a result of the narrowing is the angle satisfying the condition in an equation (EQ4).

$$( \frac{B}{Bm} ) \geq a \qquad ( EQ 4 )$$

In EQ4, B refers to the number of votes at an arbitrary angle, Bm refers to the number of votes at the angle with a maximum number of votes, and a is a preselected threshold value.

The parameter narrowing module in voting processing in the second step votes to angles present in the selected angle range. The parameter narrowing module obtains the angle having the most voted voting space as an Affine transformation matrix. The Affine transformation matrix is a displacement parameter. Notably, in a case where the number of black pixels used for the voting has a reliable proportion, the parameter narrowing module can obtain the maximum voted position as the Affine transformation matrix. In a case where the voting processing in the second step is processing for the purpose of angle identification, the parameter narrowing module performs voting processing in the third step. The voting processing in the third step performs voting processing on the voting space at an identified angle only. Since the identification of the maximum voted position is the purpose here, the number of black pixels to be used must be sufficient. The size of the range of angles in each of the steps is defined in advance.

The partial image voting module can narrow pixels subject to the voting processing by the Generalized Hough Transform. The partial image voting module narrows the voting processing based on a partial set of contour points.

In a case where the proportion of black pixels to the entire pixels within an image having W pixels in the width direction and H pixels in the height direction is G %, the number of black pixels in the image is (G*W*H/100). Therefore, the total amount of processing is M*(the square of (G*W*H/100)) where the amount of processing when the voting processing by the Generalized Hough Transform is performed once on the entire black pixels of the template image information 18 and an input image information.

In the Generalized Hough Transform, whether a voted position at a maximum value (peak) appears or not is important. Therefore, the voting processing is not required to perform on all black pixels if the peak appears. If the voting processing is performed fewer times, the processing time can be reduced. However, in a case where the number of black pixels of the template image information 18 and the number of black pixels of input image information are reduced to F %, for example, the precision of the calculation of a displacement parameter decreases. More specifically, the rate of voting to a position to be voted decreases to ((the square of F)/100) % where the voting rate is 100% in a case where the voting processing is performed on all of the black pixels.

Accordingly, according to this embodiment, the number of black pixels of the input image information 17 is only reduced. For example, a manager preselects the proportion of the number of black pixels to be used for processing of outputting a corrected image among the number of the entire black pixels of the input image information 17. This is because, in a case where the number of black pixels of the input image information 17 is low, the result of voting with the template image information 18 has less deterioration of the statistical precision. More specifically, this is because the template image information 18 contains no noise information while the input image information 17 may contain noise information. Notably, the method is possible in which the number of black pixels of the template image information 18 is reduced before the processing of the Generalized Hough Transform is performed thereon. However, the precision of detection decreases when the number of black pixels of the template image information 18 is reduced.

The number of black pixels to be reduced can be changed properly according to the processing ability of the computer that performs the Generalized Hough Transform. By doing this operation, the partial image voting module can reduce the processing time by performing the operations of Generalized Hough Transform only on a part of black pixels of the input image information 17 to be used for voting processing.

Next, processing will be described in which the partial image pasting module outputs a corrected image of input image information from the displacement parameter of each of partial image areas calculated by the partial image voting module in S06.

The amount of calculation required in the Generalized Hough Transform increases according to the number of transformation parameters. In order to obtain the result provided by the Generalized Hough Transform in a practical Processing time, the displacements may be limited to those of Affine transformation. Therefore, in a case with a displacement including a local extension/contract (nonlinear extension/contract), it is difficult to estimate the displacement parameter. Accordingly, after a displacement parameter for each partial image area in a range allowing Affine Transformation is obtained by applying the Generalized Hough Transform, the partial image pasting module interpolates partial image areas by bilinear interpolation on image transformation parameters. The partial image pasting module can correct not only distortions by Affine Transformation but also distortions by local extensions/contracts.

The actual input image information 17 has a nonlinear extension/contract. The nonlinear extension/contract may be caused by an uneven number of rotations by an auto-feeder and/or bucking of a report paper when image information on a report is obtained by an image scanner apparatus, for example.

The partial image voting module calculates a corrected image of each partial image area. Displacement parameter values may differ among partial image areas. Therefore, a non-continuous part may occur on the boundary (misalignment) between areas when corrected images of partial image areas are merged as they are. Corrected image information resulting from correction of a local extension/contract distortion can be output if the parameter for correcting a non-continuous part to be continuous can be obtained.

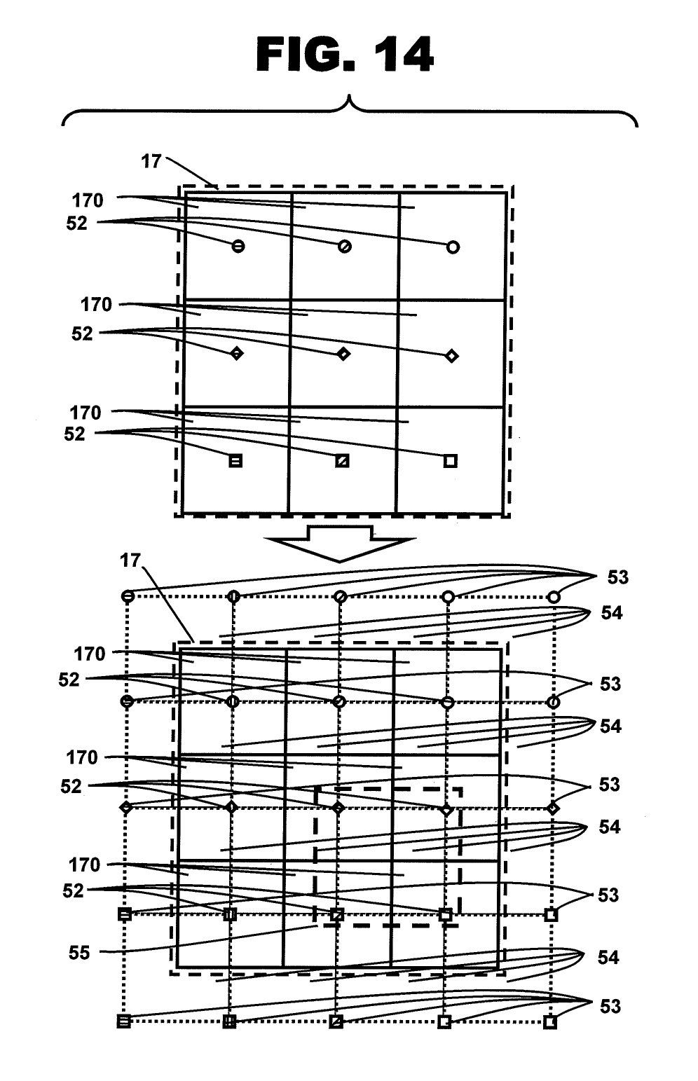

FIG. 14 is an explanatory diagram for the calculation of a displacement parameter corresponding to each pixel. The reference numeral 52 refers to a pixel correlated to the displacement parameter obtained in each partial image area 170 of the input image information 17. The displacement parameter 52 is correlated to the pixel at the center of each of the partial image areas 170, for example.

The partial image pasting module calculates a displacement parameter value corresponding to each pixel within the partial image areas 170 of the input image information 17. The correction parameter value corresponding to each pixel of the input image information 17 may be calculated by interpolating the displacement parameter values obtained in partial image areas, for example.

The reference numeral 53 refers to positions of the center of each partial image area in a case where the partial image areas are outside of the input image information 17. The reference numeral 54 refers to a rectangular area for interpolating displacement parameter values of pixels of the input image information 17 by the control module 101. The vertex of the rectangular area 54 is the pixel 52 or pixel 53. The pixel 52 of each partial image area 17 of the input image information 17 does not exist outside of the outer edge of the input image information 17. Therefore, the control module 101 cannot create the rectangular area 54. Accordingly, the control module 101 defines a virtual pixel 53 outside of the input image information 17. The position of the pixel 53 is at the vertex of the one having the same form as that of the rectangular area 54 formed by the pixel 52 within the input image information 17. The control module 101 defines a displacement parameter value for the pixel 52 of the partial image area 170 at the outer edge as the displacement parameter value of the pixel 53.

In a case where the input image information 17 has M×N partial image areas, the number of the rectangular areas 54 each for calculating the displacement parameter value of each pixel is (M+1)×(N+1). Next, the partial image pasting module calculates the displacement parameter value corresponding to each pixel.

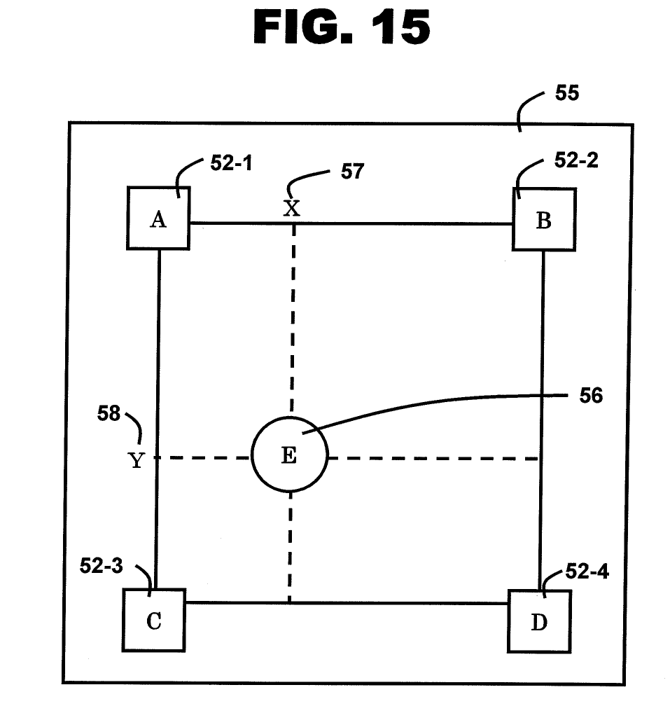

FIG. 15 is a diagram showing an area 55 in a part of the input image information 17 in FIG. 14.

The reference numeral 55 refers to an area in a part of the input image information 17. The reference numeral 52 refers to a pixel correlated to the displacement parameter value calculated for each of the partial image area 170. The displacement parameter value A is a displacement parameter value for a pixel 52-1 at the center position of a partial image area A. The displacement parameter value B is a displacement parameter value for a pixel 52-2 at the center position of a partial image area B. The displacement parameter value C is a displacement parameter value for a pixel 52-3 at the center position of a partial image area C. The displacement parameter value D is a displacement parameter value for a pixel 52-4 at the center position of a partial image area D.

The reference numeral 56 refers to a pixel subject to the calculation. The correction parameter value of the pixel 56 is E here. The reference numeral 57 refers to the horizontal position of the pixel E. The horizontal position 57 is a point X where the parallel straight line to the straight line connecting the pixel 52-1 and the pixel 52-3 from the pixel E intersects with the straight line connecting the pixel 52-1 and the pixel 52-2. The point X is located at a position where the distance from the pixel 52-1 is “X” and the distance from the pixel 52-2 is “1−X” in a case where the distance between the pixel 52-1 and the pixel 52-2 is “1”. The vertical position 58 has a point Y where the parallel straight line to the straight line connecting the pixel 52-1 and the pixel 52-2 from the pixel E intersects with the straight line connecting the pixel 52-1 and the pixel 52-3. The point Y is located at a position where the distance from the pixel 52-1 is “Y” and the distance from the pixel 52-3 is “1−Y” in a case where the distance between the pixel 52-1 and the pixel 52-3 is “1”.

The correction parameter for the pixel 56 in the input image information 17 is calculated by bilinear interpolation, for example, in a following equation (EQ5).

E=(1−X)·(1−Y)·A+X·(1−Y)·B+(1−X)·Y·C+X·Y·D (EQ5)

The partial image pasting module corrects each of the pixels of the input image information 17 with the correction parameter. The partial image pasting module outputs the corrected image as the “corrected image”.

Here, other examples to be executed by the partial image pasting module will be described. The partial image pasting module can calculate the correction parameter for each pixel by bilinear interpolation only by using a highly reliable displacement parameter. The Affine transformation matrix obtained as a result of the voting processing performed on each partial image area may not be always valid. Accordingly, the partial image pasting module determines the validity by comparing the data value calculated by the voting processing and a preset threshold value. Since the partial image pasting module uses a valid displacement parameter only to perform the correction processing on pixels as a result, the correction can be performed more accurately than the correction by directly using all displacement parameter values obtained by the Generalized Hough Transform.

The partial image pasting module determines whether the Affine Transformation matrix calculated for each partial image area is correct or not based on whether it satisfies the condition or not as in a following equation (EQ6).

$${}^{″} EB > {0}^{″} {⋂}^{ ″} \frac{MC}{EB} > {CB}^{″} \qquad ( EQ 6 )$$

Here, EB is the number of black pixels of a partial image area 170 of the input image information 17. MC is a maximum number of votes within a voting space. CB is a threshold value for determining whether it is a normal Affine transformation matrix or not. CB is the value allowing a normal Affine transformation matrix, which is statistically obtained. The partial image pasting module determines the voting result satisfying the condition in EQ6 as the Affine transformation matrix in a valid area.

Next, for a partial image area determined as having an invalid Affine transformation matrix, the partial image pasting module calculates a displacement parameter by following processing. The partial image pasting module calculates a displacement parameter for a partial image area with an invalid Affine transformation matrix by linear interpolation from the displacement parameter of other partial image area having a valid Affine transformation matrix.

According to this embodiment, the partial image pasting module may perform determination processing in order from the partial image area at the upper left of the input image information 17, for example. If a partial image area 170 having an invalid Affine transformation matrix is detected, the partial image pasting module searches the partial image areas 170 above, below and on the left and right sides of the partial image area 170 having an invalid Affine transformation matrix. If the upper, lower, left and right partial image areas 170 are partial image areas having a normal Affine transformation matrix, the partial image pasting module performs linear interpolation with the upper, lower and left and right normal displacement parameters on the displacement parameter of the partial image area 170 with an invalid Affine transformation value. The partial image pasting module performs linear interpolation with the distances from the pixels correlated with the displacement parameters of the upper, lower, left and right normal partial image areas to pixels correlated with the displacement parameter of the partial image area 170 with an invalid Affine transformation matrix and the displacement parameter values of the upper, lower, left and right normal partial image areas.

The partial image pasting module searches the processing of linear interpolation above from the partial image area 170 at the upper left of the input image information 17. Therefore, in a case where all of the areas on the first column (M×1) from the left in input image information or the area on the first row (1−N) from the top are the partial image area 170 with an invalid Affine transformation matrix, the partial image pasting module cannot find the valid area for performing linear interpolation. Accordingly, the partial image pasting module performs processing of performing linear interpolation on the partial image areas 170 on the first row or column with the partial image areas 170 on the second row or column. Since the partial image pasting module obtains all of the partial image areas 170 of the input image area 17 through the processing of linear interpolation, the displacement parameter of each of the partial image areas 170 can be a valid Affine transformation matrix.

The partial image pasting module performs processing of determining whether the displacement parameter value is valid or not. For example, a parameter with a maximum value in a voting space is determined by the voting processing executed by the partial image voting module. The partial image voting module determines the parameter the maximum value in the voting space of which is the highest as the displacement parameter value. Here, the partial image pasting module determines that the displacement parameter value is valid if the maximum value corresponding to the highest parameter is higher than a preset value. The partial image pasting module further determines the displacement parameter value as invalid if the maximum value corresponding to the highest parameter is different from the second maximum value by a preset value or larger.

The partial image pasting module performs linear interpolation processing with another valid displacement parameter value on the displacement parameter value in the partial image area with an invalid displacement parameter value after the processing of determining the validity of the displacement parameter value. Therefore, the processing of determining the validity of a displacement parameter value and the processing of linear interpolation on displacement parameter values are included in one routine.

By performing the routine including the determination processing and the linear interpolation processing by the partial image pasting module, the entire partial image areas of the input image information 17 can be valid areas. However, in a case where multiple partial image areas having problems exist locally, the partial image areas having invalid displacement parameter values may not be converted to the partial image areas having a valid displacement parameter values by performing the routine only once. Therefore, the partial image pasting module performs the routine including the determination processing and the linear interpolation processing multiple times.

The partial image pasting module obtains a valid displacement parameter correlated to the center of a partial image area. Notably, the partial image pasting module can calculate a correction parameter corresponding to each pixel of an invalid area by using a valid displacement parameter value only. However, according to this embodiment, the displacement parameter correlated to a partial image area is corrected in advance. As a result, the processing of calculating a correction parameter is advantageously simplified.

By performing the operations above, an image resulting from the correction on parallel movement, rotational movement, linear extension/contract and nonlinear extension/contract from a template image for the input image information 17 can be output. The control module 101 detects image information of the text 172 from the frame 173-1 storing a string within the corrected image and converts the image information to text code information, which can be handled by a computer.

What is claimed is:

1. A computer readable medium storing a program for executing a process of character recognition out of an image having a frame and a plurality of characters in an area, said process comprising the steps of:
dividing said area into a plurality of partial areas having a plurality of partial images, respectively;
providing a template image having a reference frame image;
calculating differences between said partial images and said reference frame image of said template image, respectively;
calculating misalignment of the image from the template image based on the average of the differences of the partial images and the reference frame image; and
recognizing said characters out of said image upon correction of said misalignment.

2. The computer readable medium according to claim 1, wherein said process of said calculating said differences of said partial image calculates at least one of parallel movement, rotational angle, and scaling of linear extension.

3. The computer readable medium according to claim 1, wherein said process of said calculating said differences of said partial image calculates by a Generalized Hough Transform.

4. The computer readable medium according to claim 1, wherein said process of said calculating said difference of said partial image calculates said difference at least one of a vertical component and a horizontal component of said frame.

5. The computer readable medium according to claim 1, wherein said process of said calculating misalignment further comprises, associating said difference to one of said pixels of said partial image, and
calculating said difference of another of said pixels on the basis of a distance from said area set said difference of said partial image.

6. The computer readable medium according to claim 1, wherein said process of said associating associates said difference at the center pixel of said partial image.

7. An apparatus for recognizing characters out of an image having a frame and a plurality of characters in an area, comprising:
a memory for storing a template image having a reference frame image; and
a processor for executing a process comprising;
dividing said area into a plurality of partial areas having a plurality of partial images, respectively;
calculating differences between said partial images and said reference frame image of said template image, respectively;
calculating misalignment of the image from the template image based on the average of the differences of the partial images and the reference frame image; and
recognizing said characters out of said image upon correction of said misalignment.

8. A method of character recognition out of an image having a frame and a plurality of characters in an area, comprising the steps of:
dividing said area into a plurality of partial areas having a plurality of partial images, respectively;
providing a template image having a reference frame image;
calculating differences between said partial images and said reference frame image of said template image, respectively;
calculating misalignment of the image from the template image based on the average of the differences of the partial images and the reference frame image; and
recognizing said characters out of said image upon correction of said misalignment.
